(19) United States
(12) Patent Application Publication
(10) Pub. No.: US 2019/0254290 A1
(43) Pub. Date: Aug. 22, 2019

(54) PIZZA TRAY OR PAN

(71) Applicant: Arlene SAUNDERS, Englewood Cliffs, NJ (US)

(72) Inventor: Arlene SAUNDERS, Englewood Cliffs, NJ (US)

(21) Appl. No.: 15/902,481

(22) Filed: Feb. 22, 2018

(51) Int. Cl. A21B 3/13

(52) U.S. Cl. CPC A21B 3/13; A21D 13/41

(57) ABSTRACT

A tray or pan for preparing and serving pizza is disclosed. The tray may be composed of steel, and more typically, low carbon steel. The wall and planar surface of the tray may be formed integrally. The steel may be of thin gauge. Such trays or pans provide a user with various cooking benefits including a reduction in cooking times.

### FIELD OF INVENTION

The present invention relates generally to a tray or pan for preparing and serving pizza. More specifically, the invention relates to thin steel pizza trays or pans with added dimensional stability.

### BACKGROUND OF INVENTION

Worldwide demand for pizza has produced considerable motivation for the continued improvement of the products and processes used for its cooking. The most desired products and processes are suitable for large-scale production and sales of pizza.

A pizza comprises a flat, usually circular dough base upon which a sauce, cheese and variety of toppings may be placed thereon. Pizza is typically cooked by organizing the raw ingredients to form an uncooked raw pizza which is placed in a pan or tray for cooking in an oven. These pans are trays are typically composed of aluminum due to its ease of manufacture and high thermal conductivities. Another method of cooking pizza involves placing the raw pizza directly onto a shelf in the oven.

However, these methods typically produce an unsatisfactory cooked pizza due to uneven cooking throughout the pizza. Such uneven cooking is manifested in the central portion of the pizza remaining uncooked and doughy while the outer peripheral regions become dry and overcooked. Increased cooking times or temperatures may help mitigate these issues, but often result in overcooked pizzas. Typically, cooking time for a pizza is 10-12 minutes at a temperature between 600-700° F.

Additionally, there is a correlation between the thickness of a pizza pan and the consistency of the crust. Generally, thicker pans or trays do not pass heat through the cooking surface to the dough as quickly thereby allowing sauce to soak into the crust. This results in a doughy, undercooked crust. Moreover, these thicker trays provide doughy, undercooked crust with longer baking times and decreased efficiency. As a pizza pan or tray becomes thinner, heat is transferred through the pan at a quicker rate therefore giving the pizza a crispier crust. The thickness of pizza trays is measured in terms of gauge. Typical gauges of pizza pans or trays are gauge 14, 18, 20, 22, and 26.

The material which pizza trays are composed of has effect on the cooking process. Most pizza trays are made from aluminum which offers high thermal conductivities and therefore quick cooking rates since heat can be transferred from the tray to the dough efficiently (as well as from the oven to the tray). However, the mechanical properties of aluminum leave much to be desired. For example, aluminum pizza trays are malleable making them prone to damage. Through repeated use, aluminum may soften and grow thin if scoured. Steel pizza trays, on the other hand, are harder than their aluminum counterparts. However, steel pizza trays have lower thermal conductivities and typically require longer cooking times for pizza. Steel pizza trays coated with metals like aluminum and tin are also used for the production of pizza trays. A thin gauge pan may help mitigate the problems associated with lower thermal conductivity of steel (or metal coated steel like aluminized steel). However, the mechanical properties of such trays also prevent them from being formed with thinner steel gauges (e.g., steel gauges greater than 20, etc.). For example, thinner pizza trays or pans of high gauge suffer dimensional stability issues like warping of the cooking surface over time.

It is therefore an object of the invention to provide a thin steel pizza pan or tray capable of producing more even cooking of a pizza with lower cooking times and without the dimensional stability issues typically associated such cooking implements.

### SUMMARY

In accordance with the foregoing objectives and others, the present invention provides a steel pizza tray or pan thinner than those that are commonly used. Such pizza trays and pans have a geometric configuration that avoids the dimensional stability issues like warping of pizza trays made of thin steel. Without wishing to be bound by theory, the invention is partially premised on the use thinner steel in pizza trays or pans to reduce the effect of low thermal conductivities in pizza trays when cooking. Accordingly, pizza trays are provided which may be composed of thin gauge steel. In some embodiments, the pizza trays may be composed of plain carbon steels (e.g., AISI Grade 1018 steel, etc.) and have a gauge of 25, 26, or 27.

The pizza tray or pan is typically composed of steel and comprises a generally planar cooking surface and a wall surrounding the planar surface. Dimensional stability of the pizza tray or pan may be achieved through incorporation of certain elements into the wall structure. In some embodiments, the wall comprises one or more (e.g., one, two, three, four, etc.) annular ribs extending around the periphery of the wall. The wall may further comprise a rim with a rolled edge. In other embodiments, the rim does not have a rolled edge (e.g., the rim may cut dough as in the CAR pizza pans by American Metalcraft, IL). In most embodiments, the one or more annular ribs are located on the wall of the pizza tray or pan between the wall and the rolled edge (i.e., the rolled edge rim is not considered an annular rib).

Methods of cooking a food product are also provided comprising placing an uncooked food product into the pizza pan or tray and heating the uncooked food product for a time period and temperature sufficient for cooking. Typically, the uncooked product is pizza. The inventive pizza trays or pans provide faster baking than other steel pizza trays or pans. For example, the typical cooking time for a pizza is 10 minutes, while an otherwise identical pan constructed as disclosed herein is able to cook a pizza in 6 minutes.

### BRIEF DESCRIPTION OF FIGURES

FIG. 1 is a perspective view of an embodiment of the pizza tray or pan comprising nibs with perforations at the apex of each nib on the planar cooking surface.

FIG. 2 is a portion of an exterior side view of the embodiment in FIG. 1 illustrating a portion of the pan up to the break-line.

FIG. 3 is a portion of the cross sectional view of the embodiment of FIG. 1 illustrating a portion of the pan wall and cooking surface up to the break-line.

FIG. 4 is a view from the top of an embodiment of the pizza tray or pan of FIG. 1 comprising nibs with perforations at the apex of each nub throughout the planar cooking surface.

FIG. 5 is a view from the top of an embodiment of the pizza tray or pan illustrating a uniform planar cooking surface.

FIG. 6 is a view from the top of an embodiment of the pizza tray or pan comprising perforations in the bottom of the pan.

FIG. 7 is a view from the top of an embodiment of the pizza tray or pan comprising nibs throughout the planar cooking surface.

### DETAILED DESCRIPTION

Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive.

As used herein, all ranges of numeric values include the endpoints and all possible values disclosed between the disclosed values. The exact values of all half integral numeric values are also contemplated as specifically disclosed in any range and subsets of the original range

Typically, the pizza tray or pan comprises one or more annular ribs extending around the periphery of a wall of the pizza tray or pan. Such pizza trays do not have the dimensional stability issues that are found in other pizza trays.

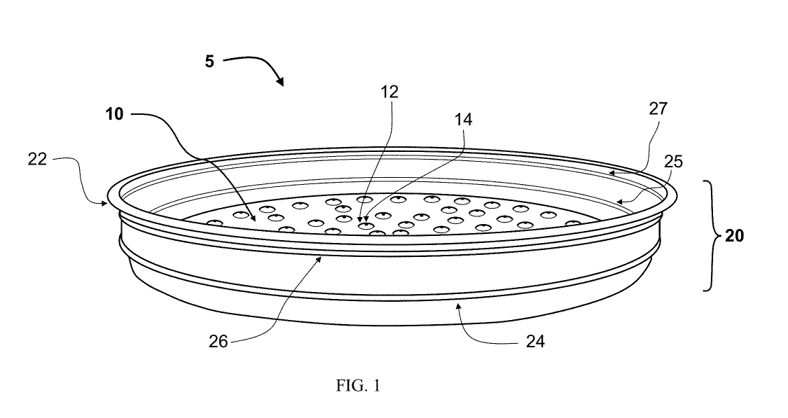

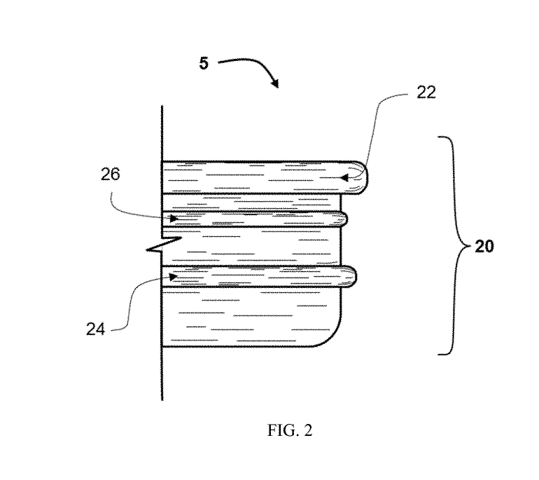

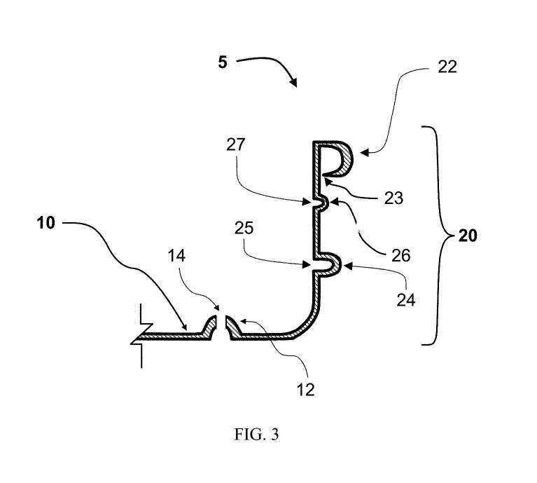

Referring now to FIGS. 1-4, various views of an embodiment of a pizza tray 5 according to the invention are shown. Pizza tray 5 comprises a planar cooking surface 10 and a wall 20 surrounding the planar cooking surface. Planar cooking surface 10 may be any shape including those with a planar cooking surface 10 that is rectangular or discoid (e.g., circular, ovular, etc.). Typically, the pizza tray or pan has a discoid cooking surface. The diameter of the cooking surface is not particularly important, but may range, for example from 8″ (inches) to 28″ or more (e.g., from 10″ to 19″, or from 12″ to 16″, etc.). In various embodiments, the diameter of the cooking surface is 10″, 11″, 12″, 13″, 14″, 15″, 16″, 17″, 18″, 19″, 20″, 21″, 22″, 23″, or 24″. In preferred embodiments, the diameter of the cooking surface is 10″, 14″, 16″, or 18″. In embodiments where the tray is not circular, the foregoing dimensions refer to the largest dimension of the tray. In the embodiment illustrated in FIGS. 1-4, planar cooking surface 10 comprises a plurality of nibs 12 which may be spherical caps protruding above the surface. Each of the nibs 12 comprise a perforation 14 located near the apex of each nib with respect to the planar cooking surface (i.e., the center point of the perforation is near the point on the spherical cap furthest from the planar cooking surface). As is typical of perforations in pizza trays or pans, perforation 14 permits the passage of heated air to the dough from the bottom of pizza tray 5.

Wall 20 rises from the periphery of the planar cooking surface 10 of tray 5. In some embodiments, the height of wall 20 may rise greater than 0.25″ from the planar surface (e.g., greater than 0.4″, greater than 0.5″, 0.25″ to 5″, 0.75″ to 5″, 0.75″ to 3.5″, 1.0″ to 5″, etc.). In some embodiments, the wall may be inclined or tapered, for example, to produce an obtuse angle with the planar surface (e.g., between 90° and 120°, etc.). In other embodiments, as shown in FIGS. 1-4, wall 20 may also rise vertically from the planar cooking surface. For example, in some embodiments when the pizza tray or pan is configured for cooking deep dish pizza, the wall rises vertically from the planar cooking surface. In the embodiment illustrated in FIGS. 1-4, wall 20 comprises rim 22 and two ribs 24 and 26. As can be seen, rim 22 comprises an outward and downward rounded rolled edge wherein material edge 23 has been rolled to meet or nearly meet wall 20 forming rolled edge rim 22. Annular ribs 24 and 26 extend around the circumference of wall 20. In this embodiment, annular rib 24 protrudes into the exterior of tray 5 and has an indentation 25 on the interior face of the wall 20 of tray 5. Similarly, rib 26 protrudes into the exterior of tray 5 and has indentation 27 on the face of wall 20 interior. In other embodiments, the annular ribs may be indented into the pan such that the annular rig comprises a protrusion above the planar cooking surface and an indentation on the exterior face of the wall. In some embodiments, each of the one or more annular ribs (e.g. one annular rib, two annular ribs, three annular ribs, four annular ribs, etc.) protrudes from the exterior of the pizza tray or pan. In other embodiments, each of the one or more annular ribs are indented into the pan wall.

The wall height as measured from the planar cooking surface to the point on the rim furthest from the cooking surface is sufficient to cook a pizza. In some embodiments, the wall height may be from 0.1″ to 5″ (e.g., 0.1″ and 1″, or between 1″ and 2″, or between 2″ and 3″, etc.). In some embodiments, the wall height may be 1″, 2″, or 3″. In some embodiments, the pizza tray or pan will comprise one annular rib and the wall height may be less than 2″ (e.g., less than 1″, less than 1.5″, less than 1.75″, less than 0.75″, etc.). In some embodiments, the pizza tray or pan will comprise two annular ribs and the wall height may be more than 0.5″ (e.g., more than 0.75″, more than 1″, more than 1.5″, etc.).

The pizza tray or pan may comprise one or more ribs. In some embodiments, pizza tray or pan may comprise one, two, three, four, or five ribs. In preferred embodiments, the pizza tray or pan comprises one or two ribs. The ribs are located along the wall between the planar cooking surface and the rim. In some embodiments, the one or more annular ribs are located on the wall of the pizza tray or pan between the wall and the rolled edge (i.e., the rolled edge rim is not be considered an annular rib). Typically the annular ribs are parallel or substantially parallel (e.g., have an angle with the planar surface of between −10° and 10° or −5° and 5° or −1° and 1°, etc.) with the cooking surface. In some embodiments, one or more annular ribs may be located in the bottom half of the wall (with respect to wall height). In some embodiments, one or more annular ribs may be located in the top half of the wall (with respect to wall height). In some embodiments, one or more annular ribs are located in the bottom half of the wall and one or more ribs are located in the top half of the wall. In some embodiments, one or more annular ribs are located in the bottom half and one or more ribs are located on the wall proximal to the lowest portion of the rim (e.g., within 0.05″ of the material edge, within 0.1″ of the material edge, within 0.25″ of the material edge, etc.).

When present, the annular ribs are dimensioned to provide dimensional stability to the pizza trays or pans. In some embodiments, the width of each said one or more ribs along the direction perpendicular to the planar cooking surface is between 0.05″ and 0.3″ (e.g., 0.05″ to 0.1″, 0.1″ to 0.15″, 0.05″ to 0.15″, 0.05″ to 0.2″, etc.). In some embodiments, the bend radius of the annular ribs is between 0.01″ and 0.2″ (e.g., 0.025″ to 0.1″, etc.). The bend radius may be measured as half the width of the annular rib. However a bend radius does not necessarily imply that the rib has a semi-circular cross sectional shape. In some embodiments, the annular rib has a semi-ovular cross sectional shape.

When present, the rolled edge of the rim is also dimensioned to provide dimensional stability to the pizza trays or pans. In some embodiments, the width of rolled edge along the direction perpendicular to the planar cooking surface is between 0.05″ and 0.3″ (e.g., 0.05″ to 0.1″, 0.1″ to 0.15″, 0.05″ to 0.15″, 0.05″ to 0.2″, etc.). In some embodiments, the bend radius of the rolled edge is between 0.01″ and 0.2″ (e.g., 0.025″ to 0.2″, 0.05″ to 0.15″, etc.).

The pizza tray or pan may be shaped as any pizza pan or tray with comprising a wall surrounding the cooking surface. In some embodiments, the pizza tray or pan may be a deep dish pizza pan. In some embodiments, the pizza tray or pan may be a CAR pan such that the wall comprises a sharp top edge which may be used to cut excess dough. In some embodiments, the pizza tray or pan comprises a tapered wall.

The pizza tray or pan may further comprise a coating. In some embodiments, the pizza tray or pan comprises a non-stick coating layer. The non-stick coating layer may be, for example, a resin bonded coating layer. In some embodiments, the pizza tray or pan may be dark coated or light coated. In some embodiments, the pizza tray or pan may be anodized hard coated. In some embodiments, the pizza tray may be silicone glaze coated. In some embodiments, the pizza tray or pan may be silicone glaze coated and anodized hard coated. For example, the nonstick coating layer may contain one or more low surface energy polymers of resin, particularly fluorinated resins or fluorinated silicone resins, and silicone resins, including, PTFE (polytetrafluoroethylene), FEP (fluorinated ethylene propylene). PFA (perfluoroalkoxy) and combinations thereof, along with reinforcing fillers such as glass, aluminum oxide titanium oxide, silicon carbide. In some embodiments, the non-stick coating is deposited as multilayer coatings with varying compositions so the exposed outer surface, though softer, is more chemically inert and water and oil repellent. The nonstick coating layer may also include one or more binder resins such as polyamide-imide (PAI), polyphenylene sulphide (PPS), polyether sulphone (PES), or a silicone and possibly also pigments. In other embodiments, the pizza tray or pan does not comprise a non-stick coating layer.

Typically, the dimensional stability of the pizza tray or pan is dependent both on the mechanical properties of the steel and the structural features described herein. In some embodiments, the tray or pan is made of steel that is not metal coated. In some embodiments, the tray or pan is made of steel that is not aluminized metal. In some embodiments, the tray or pan is made of steel that is not tin-plated steel. In other embodiments, the tray or pan is made of steel that is metal coated. In yet other embodiments, the steel may be aluminized steel or tin-plated steel.

Typically, the tray or pan is made of cold rolled steel and, more specifically, the pizza tray or pan is made of mild steel. In some embodiments, the tray or pan is made of low carbon steel (e.g., 0.05%-0.309% carbon by weight of the steel). In some embodiments, the tray or pan is made of Grade AISI 1008-1022 steel (e.g., AISI 1008, AISI 1010, AISI 1012, AISI 1014, AISI 1016, AISI 1018, AISI 1020, AISI 1022, etc.). In preferred embodiments, the steel is AISI 1018 steel. In some embodiments, the steel is AISI 1020 steel. The pizza tray or pan may have a hardness of, for example, between 50 and 170 Rockwell units (e.g., between 70 and 80 Rockwell, etc.).

Additionally, the pizza tray or pan is usually made from single unitary sheet of steel. The weight of the sheet may vary from between 10 g and 40 g (e.g., 20 g and 30 g, 15 g and 35 g, 22 g and 28 g, etc.). In some embodiments, the weight of the sheet is 26 g.

Most gauge steels suitable for pizza trays benefit from the structural features described herein. Typically, the pizza tray or pan is composed of a thin steel gauge. In some embodiments, the pizza tray or pan has a gauge of 16, 17, 18, 19, 20, 21, 22, 23, 24, 25, 26, 27, 28, 29, 30, 31, or 32. In some embodiments, the pizza tray or pan has a gauge of 22-30 (e.g., 24, 25, 26, 27, 28, etc.). In some embodiments, the pizza tray or pan may have a thickness of between 0.01″ and 0.1″ (e.g., between 0.16″ and 0.24″, etc.).

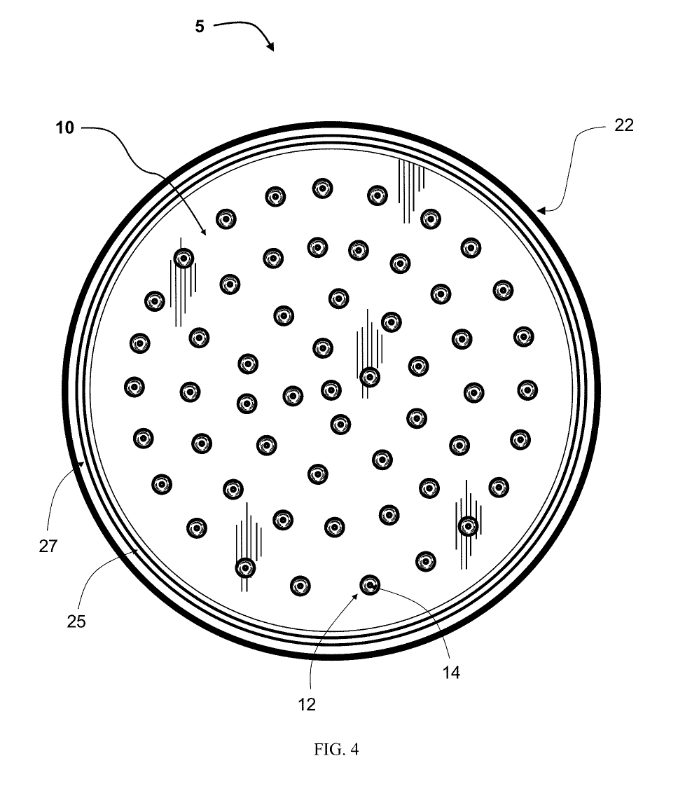

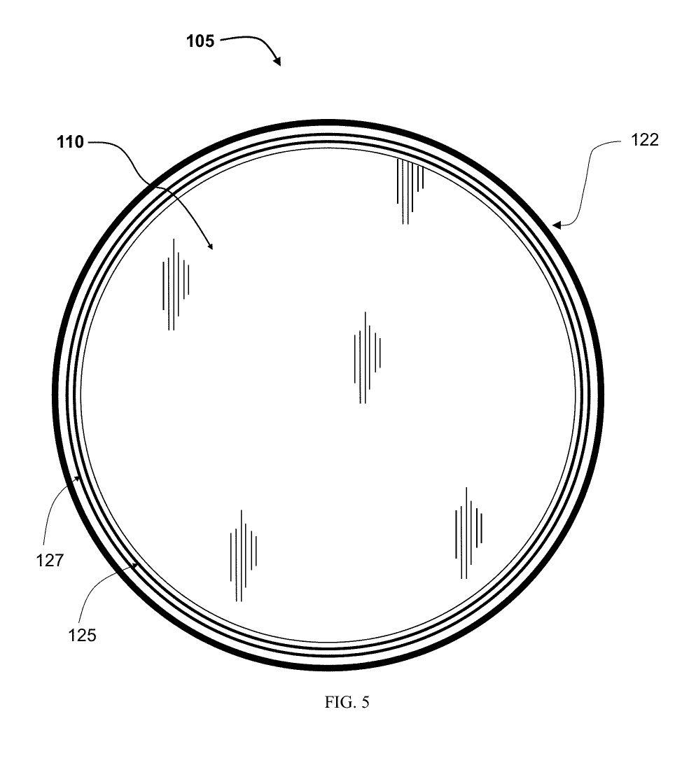

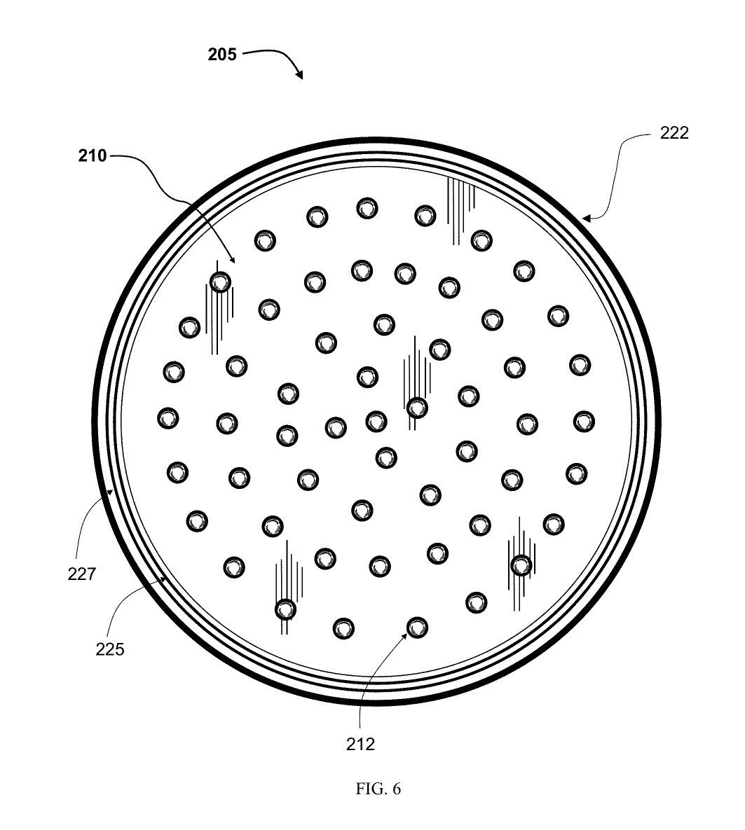

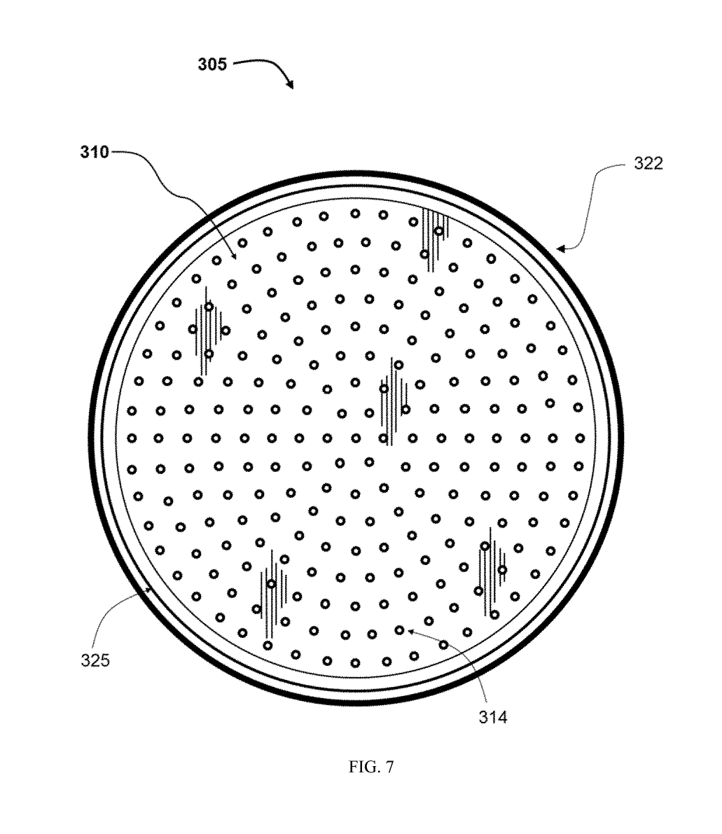

The dimensional stability of the pizza tray or pan is maintained in variations of the planar cooking surface. Accordingly, different features may be present on the planar cooking surfaces without introducing probabilities of dimensional instability like increased warping. These features may augment the cooking surface providing manipulated surfaces for different cooking. For example, in some embodiments, the planar cooking surface may comprise perforations, nibs, or combinations thereof. In other embodiments, the cooking surface may be free of these features (i.e., the cooking surface is solid and does not comprise perforations or nibs). Examples of various cooking surfaces are illustrated in FIGS. 4-7. As shown in FIG. 5 which illustrates the top view of pizza tray 105, planar surface 110 has a solid style which does not comprise perforations or nibs. As can be seen, pizza tray 105 comprises two annular ribs on the wall which are illustrated by indentations 125 and 127 and rim 122 with a rolled edge (not shown). As shown in FIG. 6, pizza tray 205 comprises planar surface 210 comprising nibs 212. Pizza tray 205 does not comprise perforations. Pizza tray 205 further comprises a wall with two annular ribs represented by indentations 125 and 127 and rim 222 with a rolled edge (not shown). As shown in FIG. 7, pizza tray 305 comprises perforations 214 without nibs on planar surface 305. Additionally, pizza tray 305 only comprises one annular rib illustrated as annular indentation 325. In some embodiments, the pizza tray or pan is perforated is super perforated.

The generally planar surface may be used to prepare a food product. An uncooked food product may be inserted into the pizza tray or pan and heated as necessary to produce a cooked food product. Typically, the food product is pizza. However, the pizza tray or pan may be used for other baking products, for example, bread and other dough based products.

As various changes can be made in the above-described subject matter without departing from the scope and spirit of the present invention, it is intended that all subject matter contained in the above description, or defined in the appended claims, be interpreted as descriptive and illustrative of the present invention. Many modifications and variations of the present invention are possible in light of the above teachings. Accordingly, the present description is intended to embrace all such alternatives, modifications, and variances which fall within the scope of the appended claims.

1. A pizza tray or pan composed of steel comprising a generally planar surface and a wall surrounding said planar surface, wherein said wall comprises one or more annular ribs extending around the periphery of said wall.

2. The pizza tray or pan according to claim 1 formed from a unitary sheet of steel.

3. The pizza tray or pan according to claim 2, wherein each of said one or more ribs has a bend radius of between 0.05″ and 0.25″ inches.

4. The pizza tray or pan according to claim 1, wherein the rim of said wall has a rounded edge.

5. The pizza tray or pan according to claim 4, wherein said rim has a rounded edge with a bend radius of between 0.1 and 0.2 inches.

6. The pizza tray or pan according to claim 1, wherein said steel is cold rolled steel.

7. The pizza tray or pan according to claim 1, wherein said steel comprises less than 0.25% carbon by weight

8. The pizza tray or pan according to claim 1, wherein said steel is low carbon steel.

9. The pizza tray or pan according to claim 1, wherein said steel is 1018 grade steel.

10. The pizza tray or pan according to claim 1, wherein said steel is thin gauge.

11. The pizza tray or pan according to claim 1, wherein said steel has a thickness of 0.041″ to 0.027″.

12. The pizza tray or pan according to claim 1, wherein said steel is gauge 25, 26, or 27.

13. The pizza tray or pan according to claim 1, wherein said pizza tray or pan comprises a non-stick coating layer.

14. The pizza tray or pan according to claim 1, wherein said generally planar surface comprises perforations, nubs, or combinations thereof.

15. The pizza tray or pan according to claim 1, wherein the height of said wall with respect to said planar surface is greater than 0.75″ and said wall comprises at least two ribs.

16. The pizza tray or pan according to claim 1, wherein the height of the wall is less than 1.5″ and said wall comprises one rib.

17. The pizza tray or pan according to claim 1, wherein said pizza tray or pan is discoid in shape.

18. A method of cooking a food product comprising heating an uncooked food product in the tray or pan of claim 1.

19. A pizza tray or pan composed of 1018 steel with gauge 25, 26, or 27.

20. A method of cooking a food product comprising heating an uncooked food product in the tray or pan of claim 19.
